(19) United States
(12) Patent Application Publication
(10) Pub. No.: US 2017/0017020 A1
(43) Pub. Date: Jan. 19, 2017

(54) FUNCTIONAL LIGHT-TRANSMISSIVE MATERIAL AND METHOD FOR MANUFACTURING THE SAME

(71) Applicants: NISHIMATSU CONSTRUCTION CO., LTD., Tokyo (JP); ITO RESEARCH INSTITUTE CO., LTD., Fujisawa-shi (JP); KURAMOTO CO., LTD., Kurihara-shi (JP)

(72) Inventors: Kengo ITO, Fujisawa-shi (JP); Naohiro TAKEDA, Fujisawa-shi (JP)

(73) Assignees: NISHIMATSU CONSTRUCTION CO., LTD., Tokyo (JP); ITO RESEARCH INSTITUTE CO., LTD., Fujisawa-shi (JP); KURAMOTO CO., LTD., Kurihara-shi (JP)

(21) Appl. No.: 15/212,526

(22) Filed: Jul. 18, 2016

(30) Foreign Application Priority Data
Jul. 17, 2015 (JP) 2015-142968

(51) Int. Cl. G02B 5/00; G02B 5/22; G02B 5/20; B05D 1/18

(52) U.S. Cl. CPC G02B 5/008; B05D 1/18; G02B 5/22; G02B 5/208

(57) ABSTRACT

The object of the present invention is to provide a novel functional light-transmissive material including tabular silver nanoparticles and the manufacturing of the same. According to the present invention, there is provided a functional light-transmissive material including: a transparent base material; an adsorption layer disposed on a surface of the transparent base material, wherein the adsorption layer contains a hydrophobic modified clay with organic compound; and tabular silver nanoparticles oriented and adsorbed on the adsorption layer. Furthermore, according to the present invention, there is provided a method for manufacturing a functional light-transmissive material, including: a step of forming an adsorption layer containing a hydrophobic modified clay with organic compound on a surface of a transparent base material; and a step of immersing the transparent base material provided with the adsorption layer in an aqueous dispersion of tabular silver nanoparticles.

### CROSS REFERENCE TO RELATED APPLICATION

This application is based upon and claims the benefit of priority under 35 USC 119 of Japanese Patent Application No. 2015-142968 filed on Jul. 17, 2015 the entire disclosures of which, including the descriptions, claims, drawings and abstracts, are incorporated herein by reference in their entirety.

### BACKGROUND OF THE INVENTION

1. Field of the Invention

The present invention relates to a functional light-transmissive material, in particular a functional light-transmissive material containing tabular silver nanoparticles.

2. Description of Related Art

When silver fine particles in the order of nanometers (silver nanoparticles) are exposed to light, free electrons in the particles cooperatively vibrate through the incident light. The resonance between the electric field, which is caused by this vibration of the free electrons, and the incident light (external electric field) generates an enhanced electric field localized on the surface of the particles. This phenomenon is referred to as localized surface plasmon resonance (LSPR). It has been known that silver nanoparticles have an effective extinction (absorption+scattering) cross section that is approximately ten times larger than its physical cross section due to LSPR, providing abnormally strong absorption and scattering of light.

The tabular silver nanoparticles having such light extinction characteristics have been examined to be applied to various optical materials, since the absorption wavelength which depends on their size can be controlled in the range from ultraviolet to near-infrared.

For example, solar radiation shielding materials containing tabular silver nanoparticles having absorption bands in the near-infrared region have attracted rising attention in recent years. In this regard, Japanese Patent No. 5703156 discloses a heat ray shielding material including a heat ray shielding layer containing tabular silver nanoparticles.

### SUMMARY OF THE INVENTION

An object of the present invention, which has been accomplished in view of the traditional art, is to provide a novel functional light-transmissive material containing tabular silver nanoparticles and a method for manufacturing the material.

As a result of intensive studies of a novel functional light-transmissive material using tabular silver nanoparticles and the method for manufacturing the material, the present inventors conceived of the following constitution and arrived at the present invention.

According to the present invention, there is provided a functional light-transmissive material including: a transparent base material; an adsorption layer disposed on a surface of the transparent base material, wherein the adsorption layer contains a hydrophobic modified clay with organic compound; and tabular silver nanoparticles oriented and adsorbed on the adsorption layer.

Furthermore, according to the present invention, there is provided a manufacturing method for a functional light-transmissive material, including: a step of forming an adsorption layer containing a hydrophobic modified clay with organic compound on a surface of a transparent base material; and a step of immersing the transparent base material provided with the adsorption layer in an aqueous dispersion of tabular silver nanoparticles.

### BRIEF DESCRIPTION OF THE DRAWINGS

FIG. 1 is a flow chart illustrating the steps of manufacturing a functional light-transmissive material according to an embodiment of the present invention;

FIG. 2 is a schematic diagram illustrating preparation of tabular silver nanoparticles;

FIG. 3 is a schematic diagram illustrating tabular silver nanoparticles oriented and adsorbed on a transparent substrate;

FIG. 4A is a schematic diagram illustrating a layer configuration of a solar radiation shielding material according to an embodiment of the present invention;

FIG. 4B is a schematic diagram illustrating a layer configuration of a solar radiation shielding material according to an embodiment of the present invention;

FIG. 4C is a schematic diagram illustrating a layer configuration of a solar radiation shielding material according to an embodiment of the present invention;

FIG. 5 shows the absorption spectra of aqueous dispersions of tabular silver nanoparticle;

FIG. 6 shows the transmission spectra of a functional light-transmissive material according to an embodiment of the present invention; and

FIG. 7 shows the difference spectra of a functional light-transmissive material according to an embodiment of the present invention.

### DESCRIPTION OF THE PREFERRED EMBODIMENT

The present invention will now be described with reference to the embodiments shown in the attached figures. The embodiments should not be construed to limit the present invention.

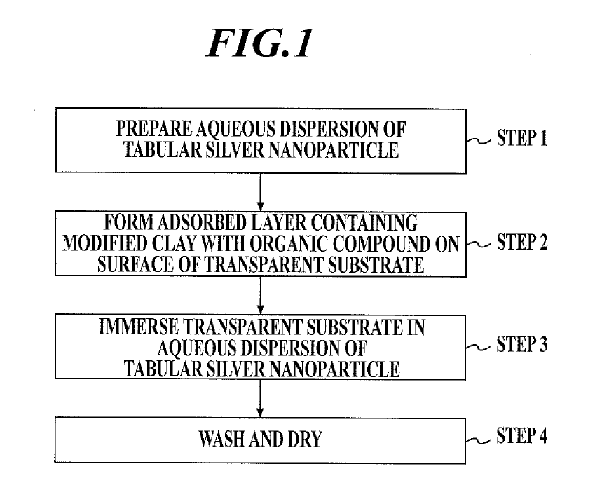

First, a method for manufacturing a functional light-transmissive material according to an embodiment of the present invention will be described with reference to FIG. 1.

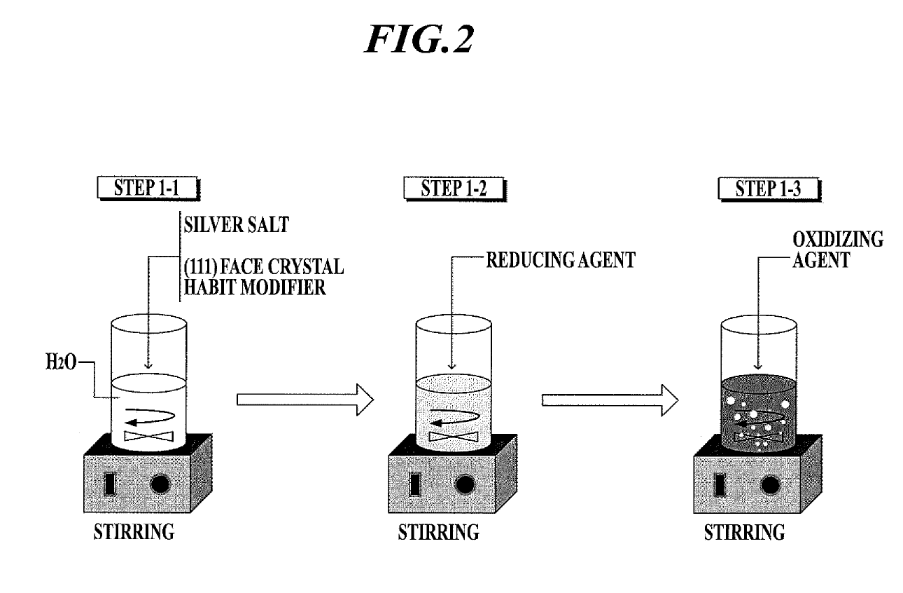

In Step 1, an aqueous dispersion of tabular silver nanoparticles is prepared by liquid-phase reduction. It is known that the wavelength region causing absorption and scattering of light arising from localized surface plasmon resonance depends on the crystal size of tabular silver nanoparticles; hence, the crystal size of the tabular silver nanoparticles should be controlled in Step 1 such that a required light absorption range is covered for the functional light-transmissive material. With reference to FIG. 2, a preferred method of preparing an aqueous dispersion of tabular silver nanoparticles will now be described.

In Step 1-1, a silver ion aqueous solution containing a crystal habit modifier is prepared. Specifically, a silver salt such as silver nitrate (AgNO₃) and a crystal habit modifier are added to vigorously stirred water (preferably pure water, more preferably ultrapure water) to prepare the silver ion aqueous solution containing the crystal habit modifier. A preferred example of the crystal habit modifier usable in this embodiment is citric acid, which can be selectively adsorbed on the (111) face of silver crystals.

In subsequent Step 1-2, while the silver ion aqueous solution described above is being vigorously stirred, a reducing agent is added. The added reducing agent reduces silver ions in the starting solution to generate very fine silver seed crystals. A typical example of the reducing agent usable in this embodiment is sodium tetrahydroborate (NaBH₄).

In subsequent Step 1-3, while the resulting aqueous dispersion containing fine silver crystals described above is being vigorously stirred, an oxidizing agent is added. A preferred example of the oxidizing agent usable in the present embodiment is hydrogen peroxide (H₂O₂). The addition of the oxidizing agent gives rise to an increase in solubility of metal silver in the aqueous dispersion and promotes partial reionization of fine silver crystals. In order to constantly keep a certain level of silver ions in the reaction system over the process, the oxidizing reagent is intermittently added in several times or is continuously added while its flow rate is being controlled. Ostwald ripening proceeds under such condition, accelerating selective growth of larger crystals and disappearance of smaller crystals. As a result, tabular silver nanoparticles with an increased diameter in the principal plane are manufactured as a main component in the reaction system.

The resulting tabular silver nanoparticles with enlarged sizes have an absorption band in the visible to near-infrared region due to localized surface plasmon resonance. In this embodiment, the crystalline sizes of the tabular silver nanoparticles can be controlled by adjusting the concentrations of the silver ions and crystal habit modifier in the Step 1-1 and the amount of reducing agent to be added, the stirring efficiency, and the reaction temperature in Step 1-2.

With reference to FIG. 1 again, the method will be further described.

In subsequent Step 2, an adsorption layer containing modified clay with organic compound is formed on a surface of a transparent base material. This transparent base material is used as a substrate of a functional light-transmissive material, and a substrate of an appropriate type is prepared for its application. Examples of the transparent base material include glass substrates, plastic substrates, metal oxide substrates, and flexible materials such as plastic sheets.

In a first stage of Step 2, modified clay with organic compound is added with mixing and stirring to an organic solvent such as toluene to prepare an organic dispersion of the modified clay with organic compound. The modified clay with organic compound represents clay (phyllosilicate) of which interlayer cations are replaced with organic cations, and is preferably smectite. It is preferred to use modified clay with organic compound having high hydrophobicity, which can be dispersed in organic solvents having high hydrophobicity such as toluene in a high concentration (several wt %).

In this embodiment, a charge transfer boron polymer with a nitrogen atom-boron atom complex structure may be added to the organic dispersion of the modified clay with organic compound. The addition of the charge transfer boron polymer can give rise to antibacterial activity and electro-conductivity to the final product, i.e., the functional light-transmissive material.

The prepared transparent base material was then immersed in the organic dispersion of the modified clay with organic compound. During this process, the modified clay with organic compound in the organic solvent dispersion is adsorbed on the surface of the transparent base material to form a layer that functions as an adsorption layer on which tabular silver nanoparticles are to be oriented and adsorbed. The layer of modified clay with organic compound is hereinafter referred to as an adsorption layer. The adsorption layer may be formed by applying the organic dispersion of the modified clay with organic compound on the surface of the transparent base material by any proper method.

Steps 1 and 2 are described above in this order; however, Steps 1 and 2 may be performed in any order in the present invention.

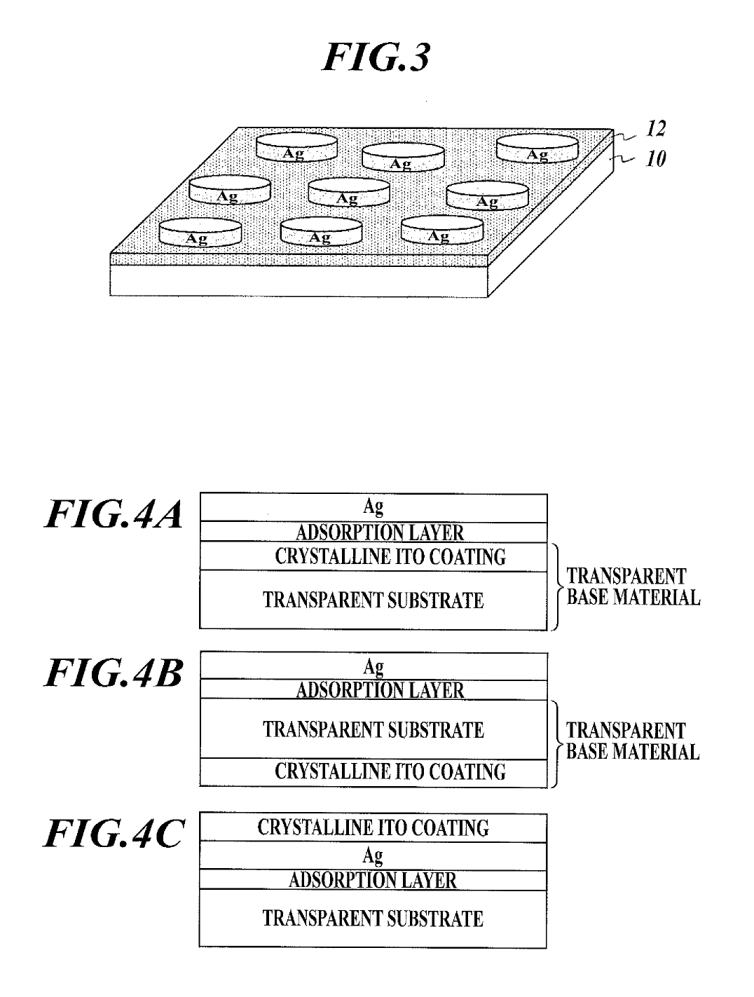

In subsequent Step 3, the transparent base material that is provided with adsorption layer prepared in Step 2 is immersed in the aqueous dispersion of tabular silver nanoparticles prepared in Step 1 for a certain time. During the immersion, the tabular silver nanoparticles are oriented and adsorbed on the adsorption layer formed on the transparent base material. FIG. 3 is a schematic diagram illustrating the oriented adsorption of tabular silver nanoparticles onto the adsorption layer 12 formed on the transparent base material 10. As shown in FIG. 3, the tabular silver nanoparticles are plane-oriented such that the principal plane is substantially parallel to the surface of the transparent base material 10.

The present inventors have found that the tabular silver nanoparticles are oriented and adsorbed by self-organization onto the transparent base material 10 without association or aggregation between particles so as to have a moderate density. The inventors infer that the modified clay with organic compound having high hydrophobicity adsorbed on the base material surface repels water and thus the tabular silver nanoparticles having higher affinity with the modified clay with organic compound than water are attracted and adsorbed with the plane-oriented manner.

Finally, in Step 4, the transparent base material is taken out from the aqueous dispersion of tabular silver nanoparticles, is thoroughly washed with water, and is completely dried. The coating treatment may be carried out over the adsorbed surface of the tabular silver nanoparticles, if necessary. A functional light-transmissive material according to the embodiment is thereby completed.

The manufacturing method of the functional light-transmissive material according to the embodiment is described above. Since the conventional functional light-transmissive material containing tabular silver nanoparticles is manufactured through preparation of coating solution containing tabular silver nanoparticles and then application of the solution onto the transparent base material, the concentration of an aqueous dispersion of tabular silver nanoparticles and the redispersion of the concentrated aqueous dispersion in a binder solution must be required.

In contrast, an aqueous dispersion of tabular silver nanoparticles prepared by liquid-phase reduction is used without further treatment in the case of the method according to this embodiment, which does not require a step of preparing the coating solution. In addition, the method according to this embodiment involves mere immersion of the transparent base material to the aqueous dispersion of tabular silver nanoparticles for the oriented adsorption by self-organization of the tabular silver nanoparticles to the base material and thus does not require large coating equipment. During this process, minimal tabular silver nanoparticles are adsorbed without association or aggregation, decreasing the amount used of silver. The method of the embodiment accordingly results in a reduction in production cost and a reduction in scale of the production facility.

The method for manufacturing the functional light-transmissive material according to this embodiment is described above. Application of the functional light-transmissive material will be now described.

In the functional light-transmissive material according to the embodiment, tabular silver nanoparticles are present on the base material without association or aggregation between particles so as to have a moderate density and thus have the light absorption characteristics similar to those of tabular silver nanoparticles in the aqueous dispersion. Thus, the functional light-transmissive material according to this embodiment has a light absorption band in the wavelength region depending on the crystal size of the tabular silver nanoparticles. In other words, the functional light-transmissive material according to this embodiment can have a desired color through adjustment of the light absorption band in the visible region. The coloring in this case occurs by light absorption due to the localized surface plasmon resonance, which may cause higher light resistance than dye.

The functional light-transmissive material according to this embodiment can be used as an ultraviolet ray shielding material by setting the light absorption band to an ultraviolet region or as a solar radiation shielding material for reducing heat due to solar radiation by setting the light absorption band to a near-infrared region.

In the case of use of the functional light-transmissive material as a solar radiation shielding material, the transparent base material should preferably be combined with a crystalline indium tin oxide (ITO) coating. Since ITO has a light absorption band in an infrared region of 1200 nm or more, the solar radiation shielding material including the transparent base material that contains oriented and adsorbed tabular silver nanoparticles having a light absorption band in the near-infrared region and is combined with the crystalline ITO coating can shade infrared rays over a broad wavelength range and thus exhibits higher heat shielding effect.

FIGS. 4A to 4C are schematic diagrams illustrating layer configurations of a solar radiation shielding material including a crystalline ITO coating. FIG. 4A illustrates a solar radiation shielding material that includes a transparent base material consisting of a transparent substrate made of, for example, glass and a crystalline ITO coating formed thereon, an adsorption layer on the ITO coating, and tabular silver (Ag) nanoparticles oriented and adsorbed on the adsorption layer. FIG. 4B illustrates a solar radiation shielding material that includes a transparent base material consisting of a transparent substrate made of, for example, glass and a crystalline ITO coating formed thereunder, an adsorption layer on the opposite side (the far side from the crystalline ITO coating) of the transparent substrate, and tabular silver (Ag) nanoparticles oriented and adsorbed on the adsorption layer. FIG. 4C illustrates a solar radiation shielding material that includes a transparent base material, an adsorption layer formed thereon, tabular silver (Ag) nanoparticles oriented and adsorbed on the adsorption layer, and a crystalline ITO coating formed thereon. The crystalline ITO coating can be formed on the glass transparent substrate by any known process, such as vacuum deposition, sputtering, sol-gel coating, or pyrolytic coating.

The embodiment of the present invention is described above. The embodiment should not be construed to limit the present invention, any modification having the advantageous effect of the embodiment should also be included in the present invention as long as a person skilled in the art can readily conceive.

### EXAMPLES

The functional light-transmissive material of the present invention will now be described in further details by way of the following examples, which should not be construed to limit the present invention.

(Preparation of Aqueous Dispersion of Tabular Silver Nanoparticles)

Three different tabular silver nanoparticles were prepared by the following procedure. All the reagents used were special grades available from Wako Pure Chemical Industries, Ltd.

(Preparation of Tabular Silver Nanoparticles A)

While ultrapure water (144 ml) was being stirred, a 150 mM trisodium citrate aqueous solution (1.5 ml) and then 50 mM silver nitrate aqueous solution (300 μl) were added to the water to prepare a starting solution. While the starting solution was being vigorously stirred, a 100 mM sodium tetrahydroborate aqueous solution (1.5 ml) was added as a reducing agent to the starting solution.

Immediately after confirmation of coloring of the aqueous solution to pale yellow due to the addition of the reducing agent, 30% hydrogen peroxide water (360 μl) was added and stirring was continued. After approximately one hour stirring, the solution was further stirred for 24 hours under a milder stirring condition to yield an aqueous dispersion containing silver nanoparticles (silver concentration: 0.001 wt %).

While ultrapure water (125 ml) was being stirred, the aqueous dispersion of silver nanoparticles (25 ml) prepared above and then a 50 mM ascorbic acid aqueous solution (170 μl) were added to the water. A 0.125 mM silver nitrate aqueous solution (360 ml) was then added at a rate of 3 ml/min and, at the same time, a 50 mM ascorbic acid aqueous solution (340 μl) was added in two parts. A 0.250 mM silver nitrate aqueous solution (120 ml) was added at a rate of 3 ml/min and, at the same time, a 50 mM ascorbic acid aqueous solution (340 μl) was added in two parts to yield an aqueous dispersion containing tabular silver nanoparticles A (silver concentration: 0.0013 wt %).

(Preparation of Tabular Silver Nanoparticles B)

While ultrapure water (900 ml) was being stirred, the aqueous dispersion (200 ml) containing tabular silver nanoparticles A prepared above and then a 50 mM ascorbic acid aqueous solution (350 μl) were added to the water. While a 0.125 mM silver nitrate aqueous solution (1920 ml) was being added at a rate of 6 ml/min, a 50 mM ascorbic acid aqueous solution (2450 μl) was added in seven parts. While a 0.250 mM silver nitrate aqueous solution (960 ml) was being added at a rate of 6 ml/min contemporaneously, a 50 mM ascorbic acid aqueous solution (2800 μl) was added in eight parts to yield an aqueous dispersion containing tabular silver nanoparticles B (silver concentration: 0.0014 wt %).

(Preparation of Tabular Silver Nanoparticles C)

While ultrapure water (235 ml) was being stirred, a 450 mM trisodium citrate aqueous solution (2.5 ml) and then a 100 mM silver nitrate aqueous solution (750 μl) were added to the water to prepare a starting solution. While the starting solution was being vigorously stirred, a 300 mM sodium tetrahydroborate aqueous solution (3.75 ml) was added as a reducing agent.

Immediately after a color change of the aqueous solution to pale yellow by addition of the reducing agent was confirmed, 30% hydrogen peroxide water (900 μl) was added with stirring. While the solution was being stirred, 30% hydrogen peroxide water (900 μl) was added every one hours seven times in total, and the solution was further stirred under a mild stirring condition for 24 hours to yield an aqueous dispersion containing tabular silver nanoparticles C (silver concentration: 0.003 wt %).

<Measurement of Absorption Spectra of Aqueous Dispersion Containing Tabular Silver Nanoparticles>

Absorption spectra of the aqueous dispersions containing tabular silver nanoparticles A, B, and C, respectively, were measured with a spectrophotometer (v-670UV/Vis/NIR made by JASCO) where the path length of cell was 2 mm, and each aqueous dispersion was measured without dilution. Ultrapure water was used as a reference.

FIG. 5 is a graph of the measured absorption spectra. No absorption band (approximately 400 to 420 nm) assigned to non-tabular silver nanoparticles was found in the spectra of these aqueous dispersions. The results indicate that tabular silver nanoparticles A, B, and C consist substantially of tabular silver nanoparticles.

The spectra of the aqueous dispersions containing tabular silver nanoparticles A and C have maximum absorptions at 1000 nm and 1080 nm, respectively, due to the localized surface plasmon resonance. The sizes of the principal plane of the tabular silver nanoparticles A and C determined from the maximum absorption wavelengths were each approximately 150 to 200 nm. The half width of the absorption band suggested that the size distribution of tabular silver nanoparticles A is sharper than that of tabular silver nanoparticles C.

In contrast, the spectrum of the aqueous dispersion containing tabular silver nanoparticles B has an absorption band at approximately 336 nm due to the localized surface plasmon resonance. A strong absorption band was supposed to appear in the longer wavelength region due to the localized surface plasmon resonance. Consequently, the inventors infer that the principal plane of tabular silver nanoparticles B were grown to the order of micrometers, being out of the detection limit (1300 nm).

<Preparation of Glass Plate with Adsorbed Tabular Silver Nanoparticles>

Indium tin oxide (ITO) was deposited into a thickness of 200±20 nm on one side of a commercially available soda glass plate (1.1 mm thick), the soda glass plate covered with ITO coating was cut into pieces of 5 cm by 5 cm. After soda glass pieces covered with ITO coating (hereinafter referred to as a glass base material) were immersed in a 0.3 wt % toluene dispersion of lipophilic synthetic clay (Lucentite SAN available from Co-op Chemical Co. Ltd.) for two days, they were taken out. After the remaining dispersion on the glass base material was thoroughly removed, the glass base materials were spontaneously dried at room temperature for approximately two hours. Two glass base materials covered with clay coating were immersed in the aqueous dispersion containing tabular silver nanoparticles A for different times (42 hours and 94 hours), respectively. The surfaces of the taken-out glass base materials were thoroughly washed with ultrapure water. After the remaining water was thoroughly removed, the glass base materials were spontaneously dried. Finally, tabular silver nanoparticles A adsorbed on each opposite surface (no ITO is deposited) were scraped off to yield glass plates A-1 (immersed for 42 hours) and A-2 (immersed for 94 hours) of the embodiment.

After soda glass pieces with a thickness of 3.0 mm and dimensions of 5 cm by 5 cm were immersed in a 0.3 wt % toluene dispersion of lipophilic synthetic clay (Lucentite SAN available from Co-op Chemical Co. Ltd.) for two days, they was taken out. After the remaining dispersion on the soda glass pieces was thoroughly removed, the soda glass pieces were spontaneously dried at room temperature for approximately two hours. Two soda glass pieces covered with clay coating were immersed in the aqueous dispersion containing tabular silver nanoparticles B for different times (62 hours and 114 hours), respectively. The surfaces of the taken-out soda glass pieces were thoroughly washed with ultrapure water. After the remaining water was thoroughly removed, the soda glass pieces were spontaneously dried. Finally, tabular silver nanoparticles B adsorbed on the surface were scraped off to yield Samples B-1 (immersed for 66 hours) and B-2 (immersed for 114 hours) of the embodiment.

One of the soda glass pieces covered with clay coating was immersed in the aqueous dispersion containing tabular silver nanoparticles C for 261 hours, was washed with water, and then was spontaneously dried. Finally, tabular silver nanoparticles C adsorbed on the surface were scraped off to yield Sample C-1 (immersed for 261 hours) of the embodiment.

<Measurement of Transmission Spectra of Samples>

The transmission spectra of Samples A-1 and A-2 and the glass base material (soda glass covered with ITO coating) prepared as above were observed with a spectrophotometer (V-670UV/Vis/NIR made by JASCO). Air was used as a reference.

FIG. 5 illustrates transmission spectra of Samples A-1 and A-2 and the glass base material. As shown in FIG. 5, Samples A-1 and A-2 exhibit significant reductions in transmittance in the range of 700 to 1200 nm compared to that of the glass base material.

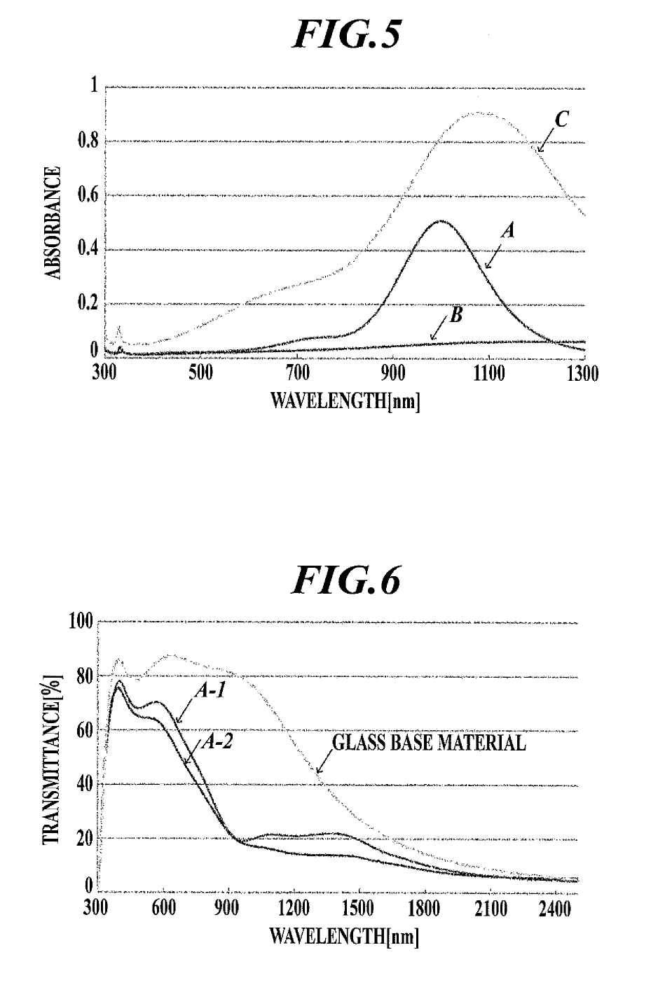

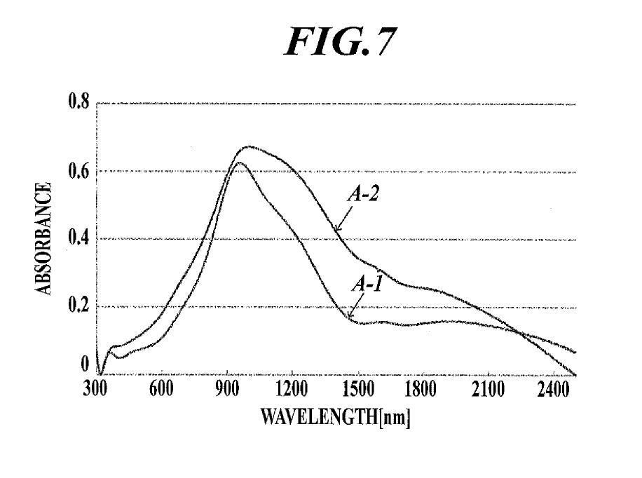

FIG. 6 illustrates difference spectra calculated by subtracting the absorption spectrum of the glass base material respectively from the absorption spectra of Samples A-1 and A-2. In comparison of the difference spectra of Samples A-1 and A-2 shown in FIG. 6 with the absorption spectrum of the aqueous dispersion containing tabular silver nanoparticles A shown in FIG. 5, these spectra significantly resemble each other in the wavelength region and in the band shape. In particular, such a tendency is noticeable in Sample A-1. These spectra demonstrate that the light absorption characteristic of tabular silver nanoparticles adsorbed on the glass base material of this embodiment, which arises from the localized surface plasmon resonance, is very similar to that of tabular silver nanoparticles contained in the aqueous dispersion.

FIG. 6 also demonstrates that the absorbance of Sample A-2 is higher than that of Sample A-1 in the longer wavelength region. Tabular silver nanoparticles densely located in the same plane without aggregation is known to cause significantly enhanced reflection in the wavelength region which is longer compared to the localized surface plasmon resonance of isolated tabular silver nanoparticles. The primary reason for explaining this phenomenon is the cooperative vibration of electric field which is induced by the localized surface plasmon resonance in large area containing many nanoparticles and enhances light (electromagnetic waves) scattering from the nanoparticles to the exterior.

In view of such knowledge, an increase in absorption in longer wavelength region in Sample A-2 probably results from tabular silver nanoparticles distributed more densely without aggregation in the same plane on the surface of glass base material as a result of prolonged immersion time compared to Sample A-1. Such densely distributed tabular silver nanoparticles without aggregation in the same plane on the surface of glass base material suggest that the orientation of the principal plane of tabular silver nanoparticles is parallel to the glass base material.

<Testing on Optical Characteristics of Samples with Adsorbed Tabular Silver Nanoparticles>

The optical characteristics of Examples (Samples A-1, A-2, B-1, B-2, and C-1) and a Comparative Example (the glass base material) were determined in accordance with JIS A5759 (film for window glass of building) at Japan Testing Center for Construction Materials. Table 1 summarizes the results. The “shielding coefficient” in Table 1 is normalized by float flat glass with a thickness of 3.0 mm.

TABLE 1

| | Transmittance of | Solar | Solar | | Heat transmission | Solar heat |
|---|---|---|---|---|---|---|
| | visible light | transmittance | reflectance | Shielding | coefficient | gain |
| Sample | [%] | [%] | [%] | coefficient | [W/m²k] | coefficient |
| A-1 | 75.0 | 50.9 | 20.8 | 0.67 | 5.2 | 0.59 |
| A-2 | 71.1 | 47.3 | 22.9 | 0.64 | 5.2 | 0.56 |
| B-1 | 74.1 | 65.3 | 16.5 | 0.81 | 6.1 | 0.71 |
| B-2 | 50.1 | 40.0 | 27.8 | 0.58 | 6.0 | 0.51 |
| C-1 | 62.6 | 50.3 | 14.1 | 0.71 | 6.0 | 0.62 |
| Glass base | 83.5 | 72.8 | 15.1 | 0.86 | 3.8 | 0.76 |
| material | | | | | | |

Above Table indicates that the solar heat gain coefficient of the glass base material (soda glass provided with an ITO coating) 0.76, which corresponded to approximately 85% of the solar heat gain coefficient of the soda glass with a thickness of 3.0 mm. The ITO thin coating is known to transmit visible light but reflect infrared light in the longer wavelength region than 1200 nm. Solar radiation shielding materials provided with ITO thin coating have been used in practice.

The solar heat gain coefficient of Samples A-1 and A-2 are 0.59 and 0.56, respectively, which are significantly lower than that of the glass base material (soda glass with the ITO coating) This is probably caused by absorption and reflection (scattering) of light in the near-infrared region (900 to 1000 nm) not reflected by the ITO thin coating due to localized surface plasmon resonance (resonant wavelength: 1000 nm) of tabular silver nanoparticles A adsorbed on the ITO thin coating. The solar heat gain coefficient of Samples B-1, B-2, and C-1, which have no ITO coating, are 0.71, 0.51, and 0.62, respectively, which are lower than that of the glass base material (soda glass with the ITO coating). These results evidentially demonstrate that the functional light-transmissive material of the present invention is suitable for practical use as a solar radiation shielding material.

<Calculation of Heat Load of Window Glass which is Exchanged for Glass Plate with Adsorbed Tabular Silver Nanoparticles>

With reference to office and wooden house models of heat-island mitigation technology field (technologies for reducing air conditioning loads by using building envelope systems), 2014 Environmental Technology Verification Program, Environment, Japan, reduction rates of air conditioning loads of a building were calculated with a simulation program for this project at a Japan Testing Center for Construction Materials, where float glass with a thickness of 3.0 mm of all the windows of the building was replaced with Sample B-1, B-2, or C-1 above. In this calculation, the simulated district was Tokyo, and the shielding coefficient and the heat transmission coefficient used were actual measurement data shown in Table 1 above. Following Table 2 shows the calculated reduction rates of air conditioning loads of the office model and house model.

TABLE 2

| | Reduction rate of | | Reduction rate of | | Reduction rate of | |
|---|---|---|---|---|---|---|
| | cooling load[%], | | heating load[%], | | air conditioning | |
| | Four months in summer: | | Coldest month: | | load[%], | |
| | June 1 to September 30 | | February 1 to 28 | | Full year | |
| Sample | Office | House | Office | House | Office | House |
| B-1 | 13.0 | 12.4 | −77.2 | −15.4 | 10.6 | 5.1 |
| B-2 | 26.7 | 26.4 | −194.9 | −37.5 | 17.5 | 7.6 |
| C-1 | 18.2 | 18.0 | −117.7 | −22.5 | 13.6 | 6.9 |

Table 3 demonstrates that all Samples (B-1, B-2, and C-1) function as a solar radiation shielding material and reduce air conditioning load in summer. The effects of reduction in air conditioning load are more noticeable in office than house, and Sample B-2 has a reduction rate of air conditioning load exceeding 25% in office. The full year reduction rate of air conditioning load in office exceeds 10% on each Sample (B-1, B-2, or C-1), although the heating load in winter increases due to solar radiation shielding. These results are comparable with known solar radiation shielding films for windows and solar radiation shielding coatings for windows.

What is claimed is:

1. A functional light-transmissive material comprising:
a transparent base material;
an adsorption layer disposed on a surface of the transparent base material, wherein the adsorption layer contains a hydrophobic modified clay with organic compound; and
tabular silver nanoparticles oriented and adsorbed on the adsorption layer.

2. The functional light-transmissive material of claim 1, wherein the principal plane of the silver nanoparticles is face-oriented so as to be substantially parallel to the base material.

3. The functional light-transmissive material of claim 1, wherein the adsorption layer further contains a charge transfer boron polymer.

4. The functional light-transmissive material of claim 1, wherein the wavelength region of absorption arising from the localized surface plasmon resonance of the silver nanoparticles includes the near-infrared region.

5. The functional light-transmissive material of claim 1, wherein the transparent base material comprises a crystalline coating of indium tin oxide (ITO).

6. A solar radiation shielding material comprising a functional light-transmissive material of claim 4.

7. A manufacturing method for a functional light-transmissive material, comprising:
a step of forming an adsorption layer containing a hydrophobic modified clay with organic compound on a surface of a transparent base material; and
a step of immersing the transparent base material provided with the adsorption layer in an aqueous dispersion of tabular silver nanoparticles.

8. The manufacturing method of claim 7, wherein the step of forming the adsorption layer comprises a substep of immersing the transparent base material in an organic dispersion of the modified clay with organic compound.

9. The manufacturing method of claim 7, wherein the step of forming the adsorption layer comprises a substep of applying an organic dispersion of the modified clay with organic compound to the transparent base material.

10. The manufacturing method of claim 8, wherein the organic dispersion of the modified clay with organic compound further comprises a charge transfer boron polymer.

11. The manufacturing method of claim 7, wherein the wavelength region of absorption arising from the localized surface plasmon resonance of the silver nanoparticles includes the near-infrared region.

12. The manufacturing method of claim 7, wherein in the step of immersing, the silver nanoparticles are oriented and adsorbed by self-organization on the adsorption layer.

13. The manufacturing method of claim 7, wherein the transparent base material comprises a crystalline indium tin oxide (ITO) coating.

14. A method of orienting and adsorbing tabular silver nanoparticles on a base material by self-organization, comprising:
a step of forming an adsorption layer containing a hydrophobic modified clay with organic compound on a surface of a base material; and
a step of immersing the base material provided with the adsorption layer in an aqueous dispersion of tabular silver nanoparticles.
